(19) United States
(12) Patent Application Publication
(10) Pub. No.: US 2003/0035712 A1
(43) Pub. Date: Feb. 20, 2003

(54) Wire rope drive mechanism for reciprocating linear motion

(76) Inventors: Douglas A. Hopper, Maryville, IL (US); Gary Skaggs, Hartford, IL (US); Gregory R. Maes, Fenton, MO (US); Joel P. Harrison, Glen Carbon, IL (US)

Correspondence Address: McDonnell Boehnen Hulbert & Berghoff, 300 South Wacker Drive, Chicago, IL, 60606, US

(21) Appl. No.: 09/830,129

(22) PCT Filed: Feb. 16, 2001
(86) PCT No.: PCT/US01/05128

(51) Int. Cl. B23Q 7/00; B23Q 5/34; F16H 19/02

(52) U.S. Cl. 414/787

(57) ABSTRACT

A drive mechanism for providing reciprocating, liner motion for a movable work piece relative to a stationary work piece is provided. The drive system includes a motor rotating a drum in forward and reverse directions about a first axis. The motor and drum are fixedly mounted with respect to the stationary work piece, such as to a housing or other structure. The system further includes an elongate, substantially non-flexible cable having a first and second ends fixed with respect to the stationary work piece. The cable further includes an intermediate portion extending between the first and second ends, with the intermediate portion being wound around the drum. First and second bearings are provided which are mounted to the movable work piece. The first bearing is positioned relative to the cable such that the intermediate portion of the cable is wound over the first bearing, and with the first bearing being positioned between the first end of the cable and the drum. The second bearing is positioned relative to the cable such that the intermediate portion of the cable is wound over the second bearing with the second bearing being positioned between the drum and the second end of the cable. Rotation of the drum in either clockwise or counterclockwise directions causes the cable to move the first and second bearings back and forth relative to the drum, thereby causing linear, reciprocating movement of the moveable work piece relative to the stationary work piece.

### BACKGROUND OF THE INVENTION

A. Field of the Invention

This invention relates generally to the field of mechanical systems for providing reciprocating, linear motion for a movable structure or work piece relative to a fixed structure or work piece. More particularly, the invention relates to a drive mechanism providing reciprocating, linear motion from rotational motion of a motor, using a novel cable or wire rope drive mechanism. The invention is susceptible to many possible uses and installations, examples being drive systems for use in automated instruments for processing biological samples, and stacking systems for stacking cards or card-like bodies in a tray, which happen to be of particular applications presently employed by the present inventors. However, other possible uses of the invention in different types of machines and systems will be apparent to persons skilled in the art from the following detailed description, and thus the invention relates, primarily, to reciprocating drive mechanisms for a moveable work piece.

B. Description of Related Art

Drive mechanisms for providing reciprocating, linear movement of a moveable work piece relative to a stationary work piece or structure are known. An example is described in the patent of Clifford W. Karl et al., U.S. Pat. No. 5,674,454, assigned to the assignee of the present invention. Generally, the '454 patent describes a stacking system for stacking flat, thin, card-like objects in a magazine. The stacking system has a moveable push plate that is used to stack the objects in the magazine. In FIG. 7 of this patent, a motor has a pinion gear with teeth which engage complementary teeth of a push rack that is coupled to the push plate. The rotation of the motor causes the push rack to move back and forth in a linear fashion, causing a push plate to move back and forth relative to the magazine and thereby providing a mechanism for stacking the objects in the magazine.

Other drive systems known in the art include Levine et al., U.S. Pat. No. 5,854,075, which describes a drive belt system for moving a carriage assembly relative to a magazine containing a plurality of slides. Other patents describing belt-type drive systems include Seto et al., U.S. Pat. No. 5,660,793; and Shindo et al., U.S. Pat. No. 5,470,533. Porte et al., U.S. Pat. No. 5,073,342, describes a simple reciprocating piston-acruated transfer mechanism. Forsstrom, U.S. Pat. No. 3,221,781 contemplates a similar type of arrangement for moving sample carriers about an analytical instrument. Other reciprocating belt and paddle-based drive mechanisms are described in the patent of William E. Seaton et al., U.S. Pat. No. 5,736,102, which is also assigned to the assignee of the present invention.

While the drive mechanism of the type described in the above-cited are work satisfactorily for many applications, the present invention is considered to be an improvement over these and other types of systems. The present drive mechanism and method is believed to provide improved reliability in extended use, and decrease the amount of maintenance for the user. Further, the design is quiet in operation. The design is easy to assemble and less costly to manufacture than systems based on the design of the above-cited Karl et al. patent.

### SUMMARY OF THE INVENTION

In a first aspect, a drive mechanism for providing reciprocating, liner motion for a movable work piece relative to a stationary work piece is provided. The drive system includes a motor rotating a drum in forward and reverse directions about a first fixed axis. The motor is fixedly mounted with respect to the stationary work piece, such as to a housing or other structure. The system further includes an elongate, substantially non-flexible cable having first and second ends, which are fixed with respect to the stationary work piece. The cable, which in a preferred embodiment takes the form of a wire rope, further comprises an intermediate portion extending between said first and second ends, with the intermediate portion being wound around the drum.

First and second bearings are provided which are mounted to or otherwise fixed with respect to the movable work piece. The first bearing is positioned relative to the cable such that the intermediate portion of the cable is wound over the first bearing, and with the first bearing being positioned along the cable between the first end of the cable and the drum. The second bearing is positioned relative to the cable such that the intermediate portion of the cable is wound over the second bearing with the second bearing being positioned along the cable between the drum and the second end of the cable. By virtue of the two bearings, cable and drum being arranged in the manner described, rotation of the drum in the forward and reverse directions moves the first and second bearings back and forth in a linear direction relative to the drum. This action thereby translates the rotational motion of the drum into linear, reciprocating movement of the moveable work piece relative to the stationary work piece. Rotation of the drum in a clock wise direction causes the moveable piece to translate in one direction, while rotation of the drum in the counterclockwise direction causes the moveable work piece to translate in the opposite direction.

In a preferred embodiment, a tension spring is coupled between the first end of the cable and the stationary work piece to apply a tension to the cable. The tension on the cable insures that there is no slippage of the cable relative to the drum. Also, in a preferred embodiment, and linear bearing having a fixed part and moveable part is provided, with the moveable work piece translating along with the moveable part of the linear bearing back and forth along a direction of motion defined by the linear bearing.

The drive mechanism of the invention can be installed in any type of system that may benefit from quiet, reliable operation of a reciprocating linear drive mechanism. Preferred embodiments would be in automated biological sample testing instruments, and in stacking systems for flat, thin card-like objects. However, the invention is not limited to such systems.

In another aspect of the invention, a method is provided for moving a moveable work piece relative to a stationary work piece using an elongate, substantially non-flexible wire rope or cable, the cable having a first end and a second end and an intermediate portion between the first and second ends. The method includes the step of attaching the first and second ends of said cable to a structure fixed with respect to the stationary work piece. The method includes the step of winding the intermediate portion of the cable about a drum coupled to a motor, with the motor fixed with respect to the stationary work piece. The intermediate portion of the cable is further wound around the first and second bearings, with the first and second bearings mounted to the moveable work piece such that the first bearing is positioned between the first end of the cable and the drum and the second bearing is positioned between the second end of the cable and the drum. The method includes the step of rotating the drum, whereby the step of rotating causes the first and second bearings to move relative to the drum and thereby move the moveable work piece relative to the stationary work piece.

### BRIEF DESCRIPTION OF THE DRAWINGS

A presently preferred embodiment of the invention is described below in conjunction with the appended drawing figures, wherein like reference numerals refer to like elements in the various views, and in which:

FIG. 1 is a schematic illustration of a wire rope drive mechanism illustrating the principle of operation of the invention;

FIGS. 2A, 2B and 2C illustrate schematically how rotation of the drum of FIG. 1 causes the moveable work piece to translate back and forth relative to the fixed work piece;

FIG. 3 is a perspective view of a wire rope drive mechanism incorporating the principles of operation of FIGS. 1 and 2A-2C.

FIG. 3A shows the principle of operation of the structure of FIG. 3;

FIG. 4 is a side elevational view of the drive mechanism of FIG. 3;

FIG. 5 is a perspective view of the wire rope or cable for the mechanism of FIGS. 3 and 4;

FIG. 6 is a perspective, partially exploded view of the drive mechanism of FIG. 3;

FIG. 7 is another perspective, partially exploded view of the drive mechanism of FIG. 3;

FIG. 8 is a perspective view of the drive mechanism of FIG. 3, shown from the rear of the device;

FIG. 9 is another perspective view of the drive mechanism of FIG. 3;

FIG. 10 is a end view of the drive mechanism of FIG. 3;

FIG. 11 is a side elevational view of the drive mechanism of FIG. 3;

FIG. 12 is a top plan view of the drive mechanism of FIG. 3;

FIG. 13 is a bottom plan view of the drive mechanism of FIG. 3;

FIG. 14 is a perspective view of the drive mechanism of FIG. 3, showing the drive mechanism installed in a support structure for a magazine holding a plurality of stacked card-like objects, with the stacking system of the type described in the prior art Karl et al. patent, U.S. Pat. No. 5,674,454; and

FIG. 15 is another perspective view of the drive mechanism and support structure of FIG. 14.

### DETAILED DESCRIPTION OF THE PREFERRED EMBODIMENT

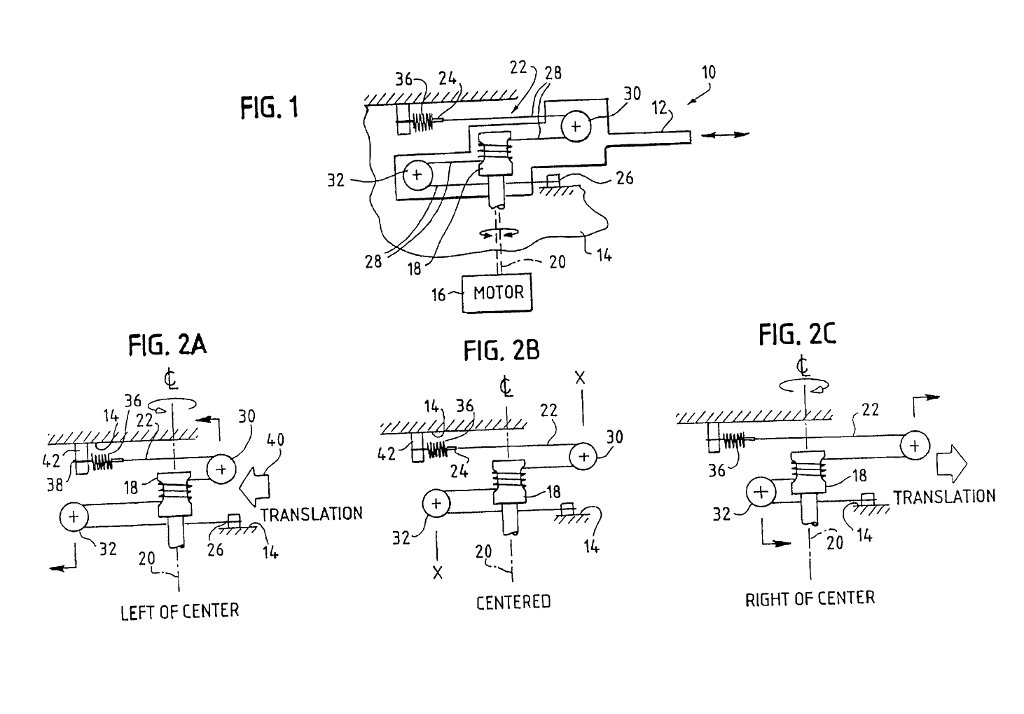

Referring now to FIG. 1, a drive mechanism indicated at 10 for providing reciprocating, liner motion for a movable work piece 12 relative to a stationary work piece or structure 14 is provided. The drive mechanism includes a motor 16 rotating a drum 18 in forward and reverse directions about a first axis 20. The motor 16 is fixedly mounted with respect to said stationary work piece 14, either directly or indirectly. An elongate, substantially non-flexible cable such as a wire rope 22 is provided. The wire cable 22 has a first end 24 attached to the stationary work piece 14 and a second end 26 which is also fixed with respect to the stationary work piece 14. The cable 22 further comprises an intermediate portion 28 extending between the first and second ends 24 and 26. The intermediate portion 28 is wound around the drum 18, for example with three wraps around the barrel of the drum as shown.

A first bearing 30 is coupled (e.g., fixedly mounted either directly or indirectly) to the movable work piece 12. The first bearing is positioned relative to the cable such that the intermediate portion 28 of the cable 22 is wound over or around the first bearing 30. The first bearing 30 is positioned along the cable 22 between the first end 24 of the cable and the drum 18, as shown in FIG. 1. A second bearing 32 is also coupled to the movable work piece 12. The second bearing is positioned relative to the cable 22 such that the intermediate portion 28 of the cable passes is wound over the second bearing 32 with the second bearing 32 being positioned along the cable 22 between the drum 18 and the second end 26 of the cable 22, as shown.

The cable is sufficiently stretched taught (or a tension spring 36 is installed) such that rotation of the drum 18 in forward and reverse directions moves the wire rope and hence the first and second bearings 30 and 32 relative to the drum 18, thus moving the moveable work piece 12 relative to the stationary work piece 14. This action is shown in FIGS. 2A, 2B and 2C. Referring to FIG. 2A, counterclockwise rotation of the drum 18 (as viewed from above) pulls the wire rope in a direction to cause the first bearing 24 to move closer to the drum 18 to the left, while reeling out more wire rope and allowing the second bearing 32 to move to the left as well. Since the first and second bearings 30 and 32 are mounted to the moveable work piece, the moveable work piece 12 of FIG. 1 translates to the left as indicated by the arrow 40. Referring to FIG. 2B, the drum is rotated the other direction until the bearings 24 and 26 (and moveable work piece) reach a centered or home position. Further rotation of the drum in the clockwise direction moves the first and second bearings further to the right relative to the drum 18, causing the moveable work piece to undergo translational motion to the right. Thus clockwise and counterclockwise rotation of the drum provide for reciprocating movement for the moveable work piece.

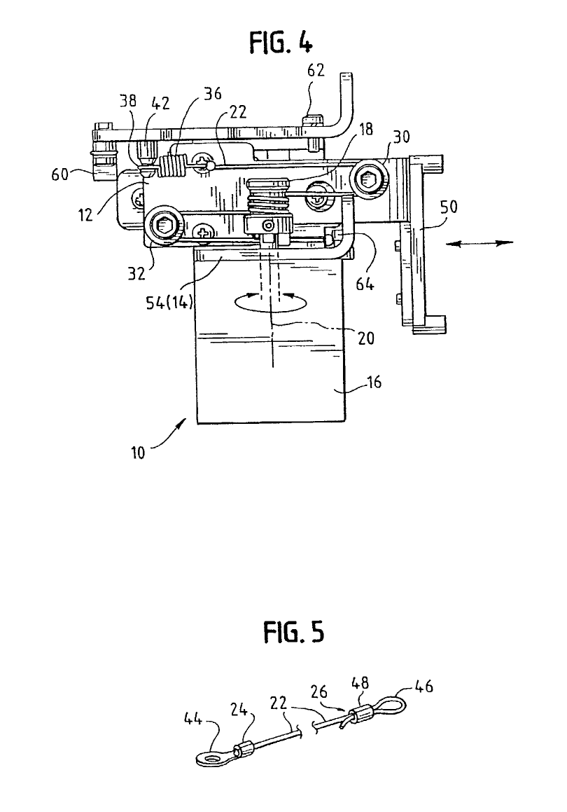

As shown in FIGS. 2A-2C, a tension spring 36 is coupled to the first end of cable 22, applying a tension to the cable 22. In the illustrated embodiment, the tension spring 36 has a loop 38 which is anchored to a post 42. The second end of the cable is anchored in any suitable fashion to the fixed work piece, such as by forming a loop in the end 26 of the cable and likewise placing it over a fixed post. FIG. 5 shows how the ends of the cables are formed in a presently preferred embodiment, with the first end 24 having a metal eye 44 that is swaged or crimped onto the cable 22, and the eye 42 hooks onto the end of the tension spring 36 of FIG. 2A. Similarly, the second end of the cable 22 is formed in a loop 46 and the loop swaged in place by swage fitting 48. As shown in FIG. 5, the cable 22 in a preferred embodiment comprises a substantially non-flexible, elongate thin wire rope with a nylon or other suitable plastic coating. The thickness and length of the cable 22 will of course depend on the particular application of the invention.

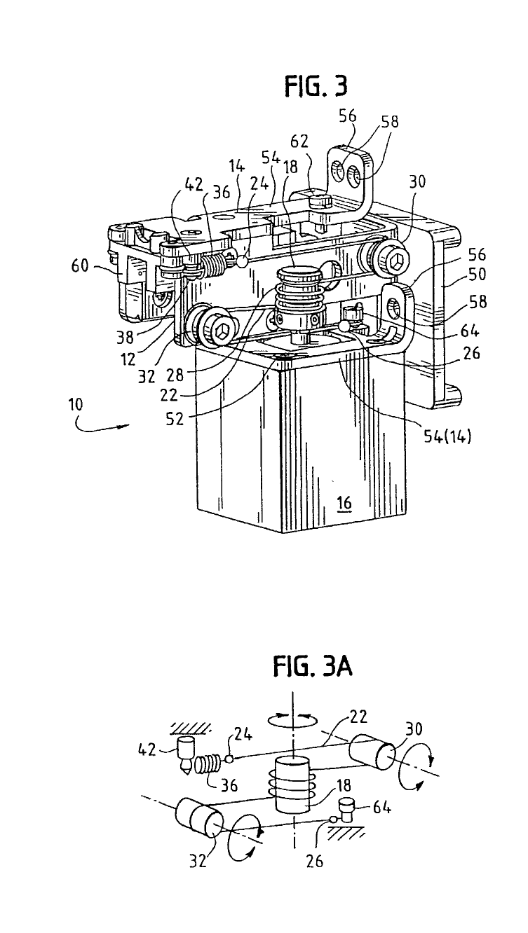

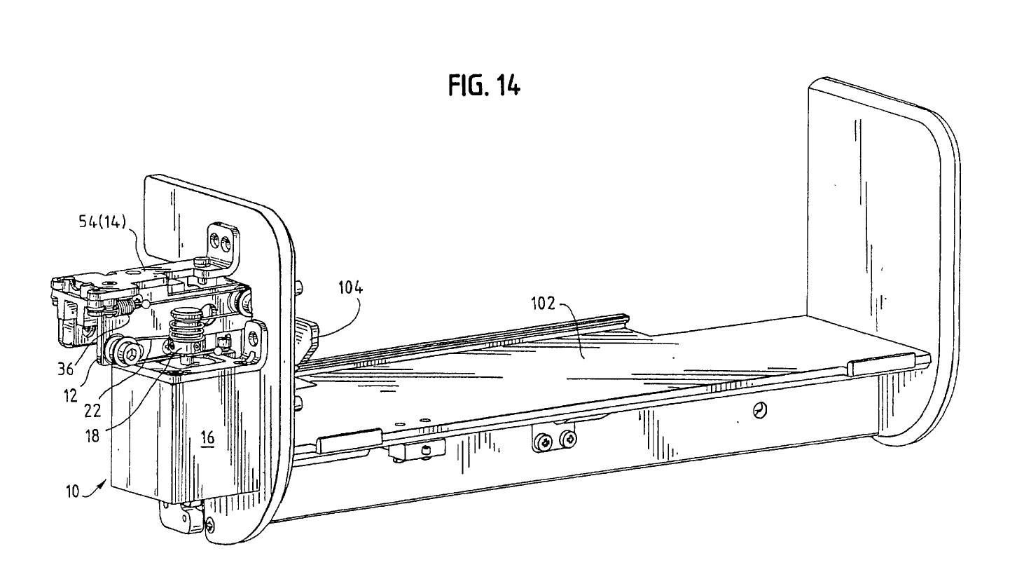

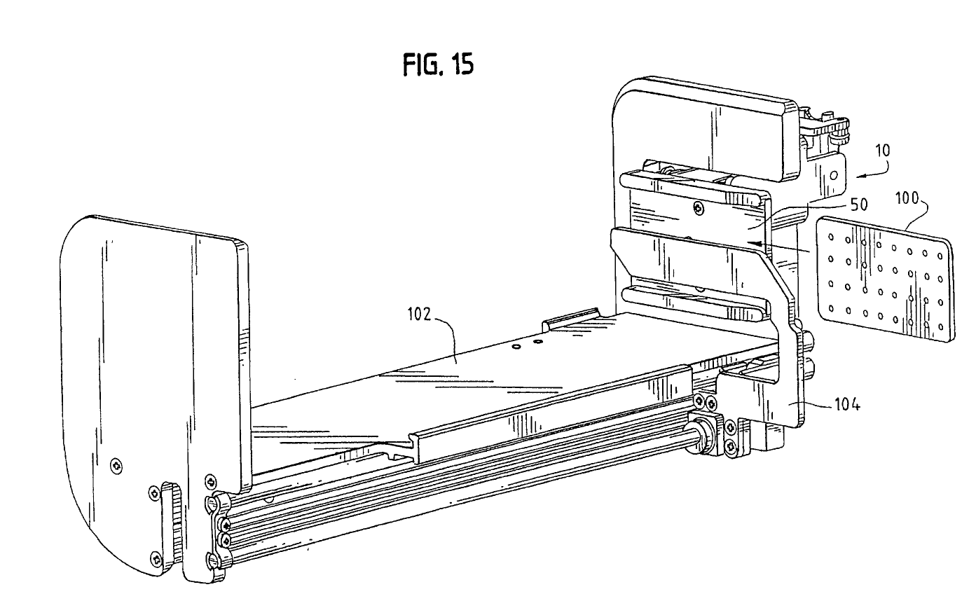

FIG. 3 is a perspective view of an embodiment of the invention in which the reciprocating drive mechanism 10 of the present invention is used to move a push plate 50, connected to the reciprocating or moveable work piece 12, back and forth to stack cards or card-like objects in a magazine. The overall magazine support structure is shown in FIGS. 14 and 15 and will be described subsequently. The drive system 10 is intended to replace the rack and pinion reciprocating drive mechanism described in the Karl et al. patent, U.S. Pat. No. 5,674,454, cited previously.

In the embodiment of FIG. 3, the motor 16 comprises a stepping motor whose operation is governed by firmware or software for the stacking disposal system, the details of which are not particularly pertinent. The motor 16 is mounted by means of a set of screws 52 to a stationary motor mount assembly 54 comprising the fixed or stationary part of the drive system. The motor mount assembly 54 includes flanges 56 with screw holes 56 that are used to mount the entire drive system 10 to the instrument incorporating the stacking assembly. FIG. 3 also shows as optical interrupt sensor 60 that is incorporated at the top of the upper portion of the motor mount assembly 54. The optical interrupt sensor 60 detects when a portion of the moveable paddle mount 12 has traveled sufficiently towards the left in the FIG. 3 such that the extreme left-hand portion of the paddle mount passes in-between the detector and emitter of the sensor 60. This signifies that the motor 16 has moved the paddle mount 12 and push plate 50 to a home position (or, equivalently, any given predetermined position).

FIG. 3 also shows an overtravel stop screw 62 that is placed directly above the moveable paddle mount 12. As shown best in FIG. 4, as the motor 16 drives the paddle mount 12 to the right, the comer 66 of the paddle mount 12 abuts the stop screw 62, preventing further movement of the paddle mount and paddle 50 to the right. FIGS. 3 and 4 also show a lower post 64 fixed with respect to the motor mount assembly 54. The loop 46 (FIG. 5) in the second end 26 of the cable 22 is placed over the lower post 64, thereby fixing the second end of the cable 22. FIG. 3A illustrates in simplified form the operation of the structure of FIG. 3.

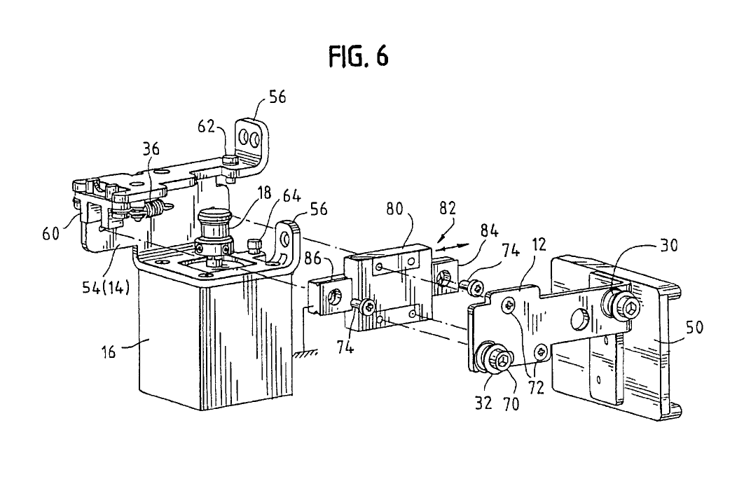

FIG. 6 is a partially exploded view of the drive system of FIG. 3. The moveable work piece or paddle mount 12 carries the two bearings 30 and 32, and the push plate or paddle 50 is in turn mounted to the paddle mount 12.

The paddle mount 12 is mounted to a translating portion 80 of a linear bearing 82 by means of screws 72. The linear bearing 82 comprises a stationary portion 84 that is attached to the motor mount assembly 54 by means of screws 74 and the translation portion 80. The translating portion 80 of the linear bearing 82 can translate back and forth along a direction defined by the groove 86 in the stationary portion 84.

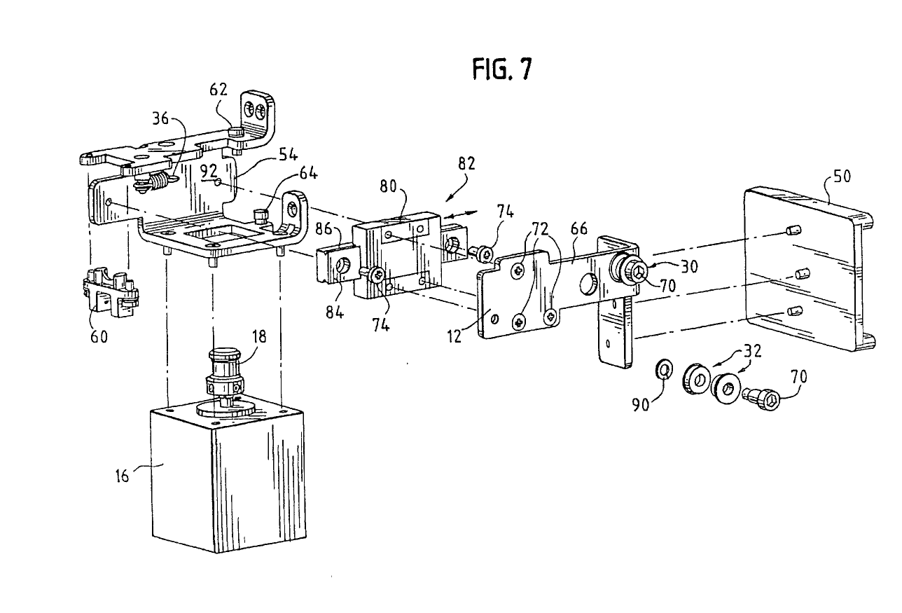

As shown best in FIG. 7, another partially exploded view of the drive mechanism 10 of FIG. 3, the bearings 30 and 32 each comprise a two-piece flanged ball bearing that is affixed to the moveable work piece or paddle mounting plate 12 by means of a screw or other equivalent type of fastening means 70 and a lock washer 90. It will be apparent from FIG. 7 that the linear bearing 82 and paddle mounting plate 12 must be secured in place to the motor mount assembly 54 prior to the insertion of the motor 16 into the motor mount assembly 54, as the drum 18 fits in front of the paddle mount 12 with the paddle mount 12 sandwiched between the drum and the rear face or wall 92 of the motor mount assembly 54 when the entire unit is assembled.

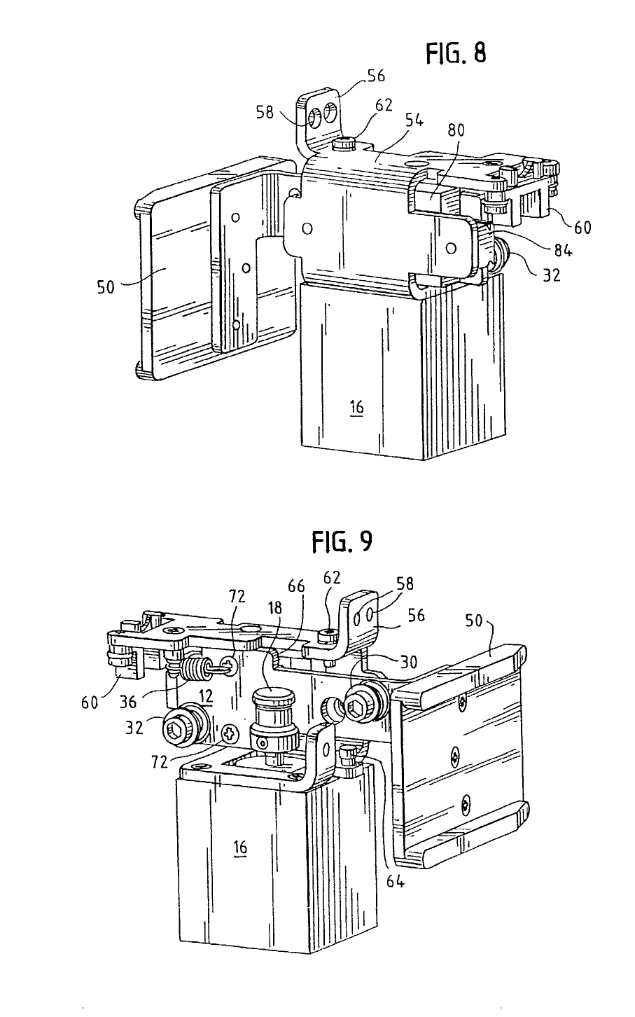

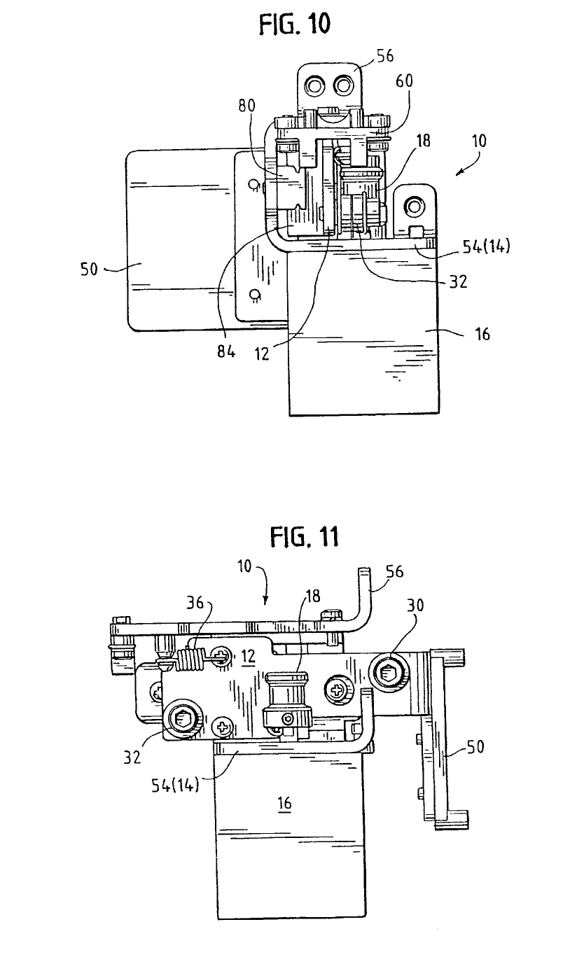

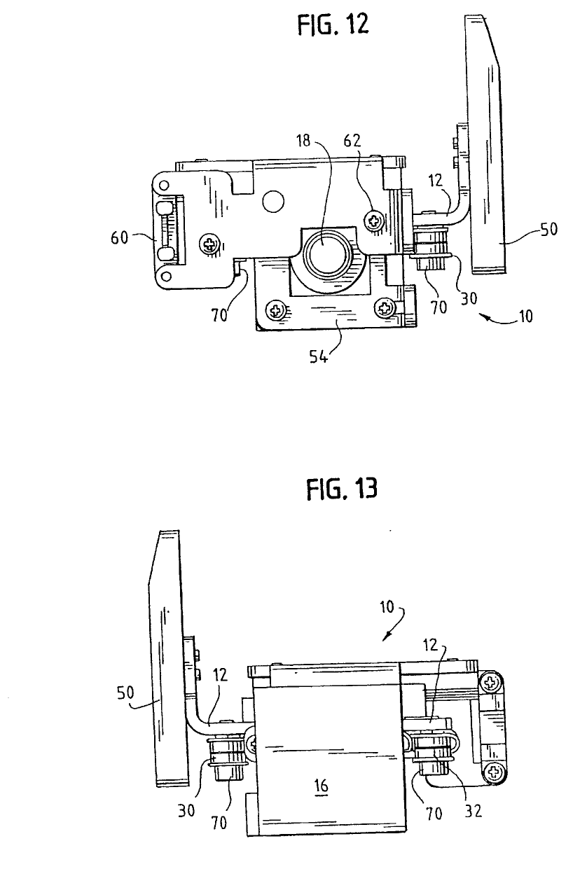

FIGS. 8 and 9 are additional perspective views of the entire drive mechanism in an assembled condition, with the cable 22 of FIG. 3 omitted for purposes of better illustrating the rest of the components of the system 10. FIG. 10 is an end view of the assembled drive system 10 (without the cable 22) as seen from the left hand side of FIG. 3, looking toward the sensor 60 and the rest of the components. FIG. 11 is another side elevational view as shown in FIG. 4, but with the cable omitted in order to better illustrate the rest of the components. FIG. 12 is a top plan view of the drive mechanism 10 of FIGS. 3-11. FIG. 13 is a bottom plan view of the drive mechanism 10.

Referring now to FIGS. 14 and 15, an implementation of the present drive system in the context of a stacking disposal system of the type described in the Karl et al. U.S. Pat. No. 5,674,454 is shown. The entire contents of the '454 patent is incorporated by reference herein. The drive system 10 is used to move the push plate 50 back and forth, so as to push a test sample card 100 into a removable magazine (not shown) for storing the cards 100. The magazine rests on a magazine support assembly 102. A spring loaded bar 104 keeps the cards that have been loaded into the magazine stacked in the magazine. As a test sample card 100 is inserted into the magazine support assembly 102, it is placed immediately in front of the push plate 50 and between the push plate 50 and the bar 104. The drive system 10 operates in a forward direction to move the push plate 50 towards the bar 104, and in the process moves the test sample card placed immediately in front of the push plate over a pair of resilient snap elements in the side of the magazine, and into a stacked condition in the magazine, as described in the Karl et al. '454 patent. The present invention provides smoother, quieter and more reliable operation of the drive system for the push plate 50, reduces user maintenance of the drive system, and is considered easier to manufacture and less costly as compared to alternative prior art designs. Further details on the construction and operation of the magazine support structure 102 and the stacking process for stacking cards are set forth in the Karl et al. '454 patent.

From the foregoing, it will be appreciated that we have described a method of moving a moveable work piece (12) relative to a stationary piece (54/14) using an elongate, substantially non-flexible wire rope or cable 22, the cable having a first end 24 and a second end 26 and an intermediate portion 28 between the first and second ends. The method comprises the step of attaching the first and second ends of the cable to a structure fixed with respect to the stationary piece 14/54, as indicated by making loops in the end of the cable and securing the loops to posts 42 and 64 as indicated in FIG. 4, either directly or with the use of a tension spring 36. The method further includes the step of winding the intermediate portion of the cable 22 about a drum 18 coupled to a motor 16, with the motor fixed with respect to the stationary piece 14/54 as indicated in FIGS. 4 and 14. The method further includes the step of further winding the intermediate portion of the cable 22 around first and second bearings 30 and 32. The first and second bearings 30 and 32 are mounted to the moveable work piece 12 (as shown in FIG. 6), such that the first bearing 30 is positioned relative to the cable 22 between the first end 24 of the cable 22 and the drum 18 and the second bearing 32 is positioned relative to the cable 22 between the second end 26 of the cable 22 and the drum 18. Finally the method includes the step of rotating the drum 18 (as indicated in FIGS. 2A, 2B and 2C), whereby the step of rotating causes the first and second bearings to move relative to the drum and thereby move the moveable work piece 12/50 relative to the stationary work piece 14/54.

Note further that the drum 18 rotates about a first axis 20 (FIG. 2A). As shown in FIGS. 2A-2C, the cable is wound about the first and second bearings 30 and 32 such that rotation of the drum 18 about the first axis 20 causes the moveable work piece 12/50 to move in a linear direction defined by the linear bearing 82 of FIG. 7 in a direction that is orthogonal to the first axis, i.e., the axis of the motor 16 and drum 18.

Further, as illustrated in FIG. 2A and 6, the moveable work piece 12/50 piece reciprocates back and forth along a path defined by the linear bearing 82, and rotation of the drum 18 in clockwise and counterclockwise directions causes the moveable work piece 12/50 to translate back and forth along the path defined by the linear bearing 82.

In one possible embodiment, the method of the present invention includes the step of providing an optical sensor 60 in close proximity to the moveable work piece 12, and detecting with the optical sensor 60 the position of the moveable work piece 12/50 relative to the stationary work piece 14/54 to thereby detect when the moveable work piece has reciprocated in the path back to a predetermined or home position.

As noted earlier, the present invention is not considered limited to the illustrated embodiment. Rather, the principles of operation of the invention are applicable to other mechanical systems having the need for linear reciprocating motion. While the presently contemplated best mode for practicing the invention is in the context of stacking test sample cards, the invention can be used for stacking other types of substantially flat and thin card-like objects. Other drive systems found in automatic biological sample testing, instruments are possible candidates for implementation of the invention. Accordingly, the true scope of the invention is to be determined by reference to the appended claims, interpreted by the foregoing description.

We claim:

1. A drive mechanism for providing reciprocating, liner motion for a movable work piece relative to a stationary work piece, comprising:
(a) a motor rotating a drum in forward and reverse directions about a first axis, said motor fixedly mounted with respect to said stationary work piece;
(b) an elongate, substantially non-flexible cable having a first end coupled to said stationary work piece and a second end coupled to said stationary work piece, said cable further comprising an intermediate portion extending between said first and second ends, with said intermediate portion being wound around said drum;
(c) a first bearing coupled to said movable work piece wherein said first bearing is positioned relative to said cable such that said intermediate portion of said cable is wound over said first bearing with said first bearing being positioned between said first end of said cable and said drum; and
(d) a second bearing coupled to said movable work piece wherein said second bearing is positioned relative to said cable such that said intermediate portion of said cable passes is wound over said second bearing with said second bearing being positioned between said drum and said second end of said cable,
(e) wherein rotation of said drum in said forward and reverse directions moves said first and second bearings relative to said drum thereby moving said moveable work piece relative to said stationary work piece and providing reciprocating movement for said moveable work piece.

2. The drive mechanism of claim 1, further comprising a tension spring coupled to said first end of said cable, said tension spring applying a tension to said cable.

3. The drive mechanism of claim 1, wherein said drive mechanism is incorporated into an automated biological sample testing instrument.

4. The drive mechanism of claim 1, wherein said drive mechanism is incorporated into a stacking system for stacking substantially flat and thin card-like objects.

5. The drive mechanism of claim 1, wherein said drive mechanism further comprises:
a linear bearing having a first portion fixed with respect to said stationary work piece and defining a direction of linear motion, and a second portion translatable relative to said first portion in a linear fashion in said direction of linear motion; and
said moveable work piece mounted to said second portion of said linear bearing; and
fastening means for fastening said moveable work piece to said second portion of said linear bearing;
wherein rotation of said drum causes said cable to move said moveable work piece in a linear direction defined by said linear bearing.

6. The mechanism of claim 1, wherein said cable comprises a wire rope.

7. A method of moving a moveable work piece relative to a stationary piece using an elongate, substantially non-flexible cable, said cable having a first end and a second end and an intermediate portion between said first and second ends, comprising the steps:
attaching said first and second ends of said cable to a structure fixed with respect to said stationary piece;
winding said intermediate portion of said cable about a drum coupled to a motor, said motor fixed with respect to said stationary piece;
further winding said intermediate portion of said cable around first and second bearings, said first and second bearings coupled to said moveable work piece such that said first bearing is positioned relative to said cable between said first end of said cable and said drum and said second bearing is positioned relative to said cable between said second end of said cable and said drum; and
rotating said drum, whereby said step of rotating causes said first and second bearings to move relative to said drum and thereby move said moveable work piece relative to said stationary work piece.

8. The method of claim 7, wherein said drum rotates about a first axis, and wherein said cable is wound about said first and second bearings such that rotation of said drum about said first axis causes said moveable work piece to move in a linear direction orthogonal to said first axis.

9. The method of claim 7, wherein said moveable work piece reciprocates back and forth along a path, and wherein rotation of said drum in clockwise and counterclockwise directions causes said moveable work piece to move back and forth along said path.

10. The method of claim 9, wherein the method further comprises the steps of:
providing an optical sensor in close proximity to said moveable work piece; and
detecting with said optical sensor the position of said moveable work piece relative to said stationary piece to thereby detect when said moveable work piece has reciprocated in said path back to a predetermined position.

11. The method of claim 7, further comprising the step of applying tension to said first end of said cable between said cable and said stationary work piece.

12. The mechanism of claim 1, further comprising an optical sensor placed in registry with a path along which said moveable work piece is moved by said cable, wherein said optical detector senses the position of said moveable work piece relative to said stationary work piece to thereby detect when said moveable work piece has been moved to a predetermined position.

13. In a stacking system for stacking substantially flat, thin card-like objects in a magazine, said stacking system further comprising a reciprocating member for moving said objects into said magazine, an improved drive mechanism for moving said reciprocating member back and forth in a reciprocating, linear fashion, the improvement comprising:
(a) a motor rotating a drum in forward and reverse directions about a first axis, said motor fixedly mounted with respect to said magazine;
(b) an elongate, substantially non-flexible cable having a first end and a second end and an intermediate portion extending between said first and second ends, with said intermediate portion being wound around said drum, said first and second ends attached to fixed structure in said stacking system;
(c) a first bearing coupled to said reciprocating member wherein said first bearing is positioned relative to said cable such that said intermediate portion of said cable is wound over said first bearing with said first bearing being positioned between said first end of said cable and said drum; and
(d) a second bearing coupled to said reciprocating member wherein said second bearing is positioned relative to said cable such that said intermediate portion of said cable passes is wound over said second bearing with said second bearing being positioned between said drum and said second end of said cable,
(e) wherein rotation of said drum in said forward and reverse directions moves said first and second bearings relative to said drum thereby moving said reciprocating member relative to said magazine and providing reciprocating movement for said reciprocating member.

14. The improvement of claim 13, further comprising a spring coupled to said first end of said cable, said tension spring applying a tension to said cable.

15. The improvement of claim 13, wherein said magazine is incorporated into an automated biological sample testing instrument.

16. The improvement of claim 13, wherein said improved drive mechanism further comprises:
a linear bearing having a first fixed portion and defining a direction of linear motion, and a second portion translatable relative to said first portion in a linear fashion in said direction of linear motion, said reciprocating member mounted to said second portion of said linear bearing either directly or indirectly;
wherein rotation of said drum causes said cable to move said reciprocating member in a linear manner in said direction of linear motion defined by said linear bearing.

17. The improvement of claim 13, wherein said cable comprises a wire rope.

18. The improvement of claim 13, further comprising an optical sensor placed in registry with a path along which said reciprocating member is moved by said cable, wherein said optical detector senses the position of said reciprocating member to thereby detect when said moveable work piece has been moved to a predetermined position.

19. The improvement of claim 17, wherein said wire rope is coated with a plastic material.

20. The mechanism of claim 6, wherein said wire rope is coated with a plastic material.
